(19) United States
(12) Patent Application Publication
(10) Pub. No.: US 2009/0189131 A1
(43) Pub. Date: Jul. 30, 2009

(54) Hoisting device of a rope section having a lifting element with two shells assembled by sliding

(75) Inventors: Paul Brun, Grenoble (FR); Jean Souchal, Grenoble (FR)

Correspondence Address: OLIFF & BERRIDGE, PLC, P.O. BOX 320850, ALEXANDRIA, VA, 22320-4850, US

(73) Assignee: POMAGALSKI, Voreppe (FR)

(21) Appl. No.: 12/318,459

(22) Filed: Dec. 30, 2008

(30) Foreign Application Priority Data
Jan. 30, 2008 (FR) 08 00500

(51) Int. Cl. B66F 3/00

(52) U.S. Cl. 254/133 R

(57) ABSTRACT

A hoisting device of a section of a rope for a mechanical ski-lift installation comprises on the one hand a lifting element designed to be positioned pressing against the rope and on the other hand means for moving the lifting element in a first direction. The lifting element is formed by a sleeve having a main axis oriented in a second direction perpendicular to the first direction, designed to be positioned around the rope section. The sleeve comprises a top shell having connection means connecting with the means for moving, a bottom shell having a support dish designed to be positioned pressing underneath said rope section, the two shells comprising complementary guiding elements for assembly by sliding in the second direction, and securing means disabling sliding between the two shells after assembly.

### BACKGROUND OF THE INVENTION

The invention relates to a hoisting device of a section of a rope for a mechanical ski-lift installation, comprising on the one hand a lifting element designed to be positioned pressing against the rope and on the other hand means for moving the lifting element in a first direction.

### STATE OF THE ART

In a mechanical ski-lift installation dedicated to transporting people by means of cars moving along a closed loop, it is known to use hauling or carrying-hauling ropes that are mobile and guided by sheave assemblies supported by intermediate towers between the loading and unloading terminals, or fixed carrying ropes resting on supports supported by shoes.

To perform maintenance operations of these different kinds of ropes, it is often necessary to hoist a rope section near the sheaves and supports. Known methods for hoisting a rope section use equipment that is not practical to implement, is sometimes complex and cumbersome, and is difficult to apply easily, quickly and in complete safety. It is a frequent occurrence for the rope lifting element to damage the rope during hoisting.

For example hoisting is often performed by means of a clamping strap arranged in a closed loop around the rope section, with a bottom turn pressing underneath the rope and a top turn closed on a fixed anchoring device above the rope, so that tightening of the strap moves the turns towards one another resulting in the rope being lifted. The lifting element is formed by the bottom turn of the strap. The small width of the strap means that such a lifting element is liable to cause local crushing of the rope.

### OBJECT OF THE INVENTION

The object of the invention consists in providing a hoisting device of a rope section for a mechanical ski-lift installation that remedies the shortcomings of the prior art.

The device according to the invention is remarkable in that the lifting element is formed by a sleeve having a main axis oriented in a second direction perpendicular to the first direction, designed to be positioned around the section and comprising:
a top shell having connection means connecting with the means for moving,
a bottom shell having a support dish designed to be positioned pressing under said section, the two shells comprising complementary guiding elements for assembly by sliding in the second direction,
and securing means disabling sliding between the two shells after assembly.

Such a lifting element in the form of a sleeve reduces the risks of the rope being damaged during hoisting due to the elongate nature of the sleeve in the second direction, which corresponds to the direction of the rope during use. This structural feature of the lifting element does in fact enable the local pressure exerted on the hoisted rope section to be reduced. A sleeve obtained by an assembly with sliding of two shells is particularly simple, practical and secure to used in situ. The weight of the hoisted rope is totally transmitted from the bottom shell in which the rope rests to the top shell moved by the means for moving at the level of the guiding parts, for enhanced safety. The only function assigned to the securing means is to prevent any possibility of relative sliding between the shells.

According to a preferred embodiment, the support dish defines a curved groove on the opposite side from the top shell. Such a support dish ensures a substantially uniform distribution of the contact pressure between the hoisted section and the support dish during hoisting. This results in additional limiting of the risks of the rope being damaged. For example, the groove can be a portion of surface of revolution having a generating line formed by an arc of a circle having a diameter that is substantially equal to that of the section to be hoisted.

Other technical features can be used either alone or in combination:
the top shell comprises two parallel securing slots running in the direction of the main axis of the sleeve, corresponding securing edges of the bottom shell engaging in these slots during assembly by sliding,
the top shell comprises an overlap dish of the rope section having two parallel free edges each comprising a securing slot over the whole length of the top shell and open onto the overlap dish,
the securing means are formed by at least one bolt having a threaded body passing through one of the shells and screwed into the other shell,
the means for moving comprise a jack having a piston linearly moving in the first direction a transmission element securedly attached to the top shell by the connection means,
the transmission element comprises a rod having a threaded free end screwed into the connection means formed by a tapped bore made in the top shell.

### BRIEF DESCRIPTION OF THE DRAWINGS

Other advantages and features will become more clearly apparent from the following description of a particular embodiment of the invention given for non-restrictive example purposes only and represented in the accompanying drawings, in which:

FIGS. 1 and 2 represent an example of a hoisting device according to the invention, respectively in the bottom position and the top position of the lifting element,

FIG. 3 represents detail A of FIG. 2,

FIG. 4 is a cross-sectional view of the bottom shell in the second direction.

### DESCRIPTION OF A PREFERRED EMBODIMENT OF THE INVENTION

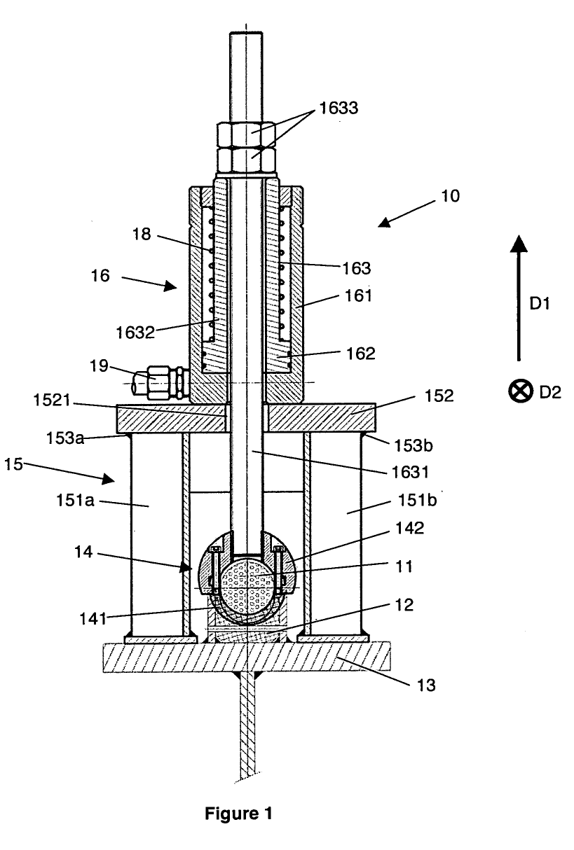

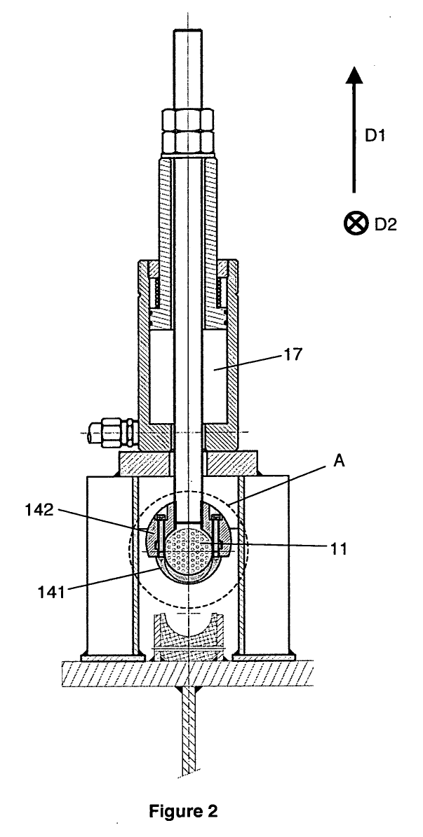

With reference to FIGS. 1 to 4, an example of a hoisting device 10 of a rope section for a mechanical ski-lift installation is represented in application to hoisting a fixed carrying rope 11 of said installation. At rest, rope 11 rests by gravity in supports 12 provided on a shoe 13 of the installation.

In the example illustrated, hoisting device 10 comprises a lifting element 14 designed to be positioned pressing on rope 11 to release the latter from supports 12. Lifting element 14 is mainly composed of a bottom shell 141 designed to support a longitudinal section of the rope 11 when hoisting is performed and a top shell 142 designed to overlap the hoisted section of rope 11, and will be described in greater detail below. Device 10 also comprises a bearing structure 15 designed to press on shoe 13 for the hoisting operation. For this purpose, bearing structure 15 is mainly composed of two feet 151a, 151b each resting on shoe 13. Each foot 151a, 151b presents the shape of a rectangular frame and is located parallel to the other foot 151a, 151b. Whereas the bottom edges of feet 151a, 151b are designed to come into contact with shoe 13, the top edges thereof support a plate 152 arranged for example perpendicularly to the main planes of feet 151a, 151b. Plate 152 is securedly attached to feet 151a, 151b by any fixing means, for example by welding as illustrated by welding beads 153a, 153b.

Lifting element 14 is connected to bearing structure 15 by means of a jack 16, for example of hydraulic or pneumatic type, mainly comprising a cylindrical body 161, a piston 162 mounted in translation in body 161 in a first direction D1 of device 10, and a transmission element 163 securedly attached to piston 162. Cylindrical body 161 is fixed to plate 152 on the opposite side from feet 151a, 151b via a bottom end, in a configuration such that direction D1 is perpendicular to the main plane of plate 152. Transmission element 163 comprises a sheath 1632 arranged in the direction of D1, the outside surface whereof is securedly attached to piston 162 and inside which there extends a securedly attached rod 1631, passing through and thus opening out onto the two ends of sheath 1632. Rod 1631 therefore has a free bottom end and a free top end, both arranged outside sheath 1632. Rod 1631 is salient from the bottom end of body 161, passing through a central opening 1521 of plate 152. The bottom free end of rod 1631 is threaded and screwed into a tapped bore 1421 made in top shell 142 of lifting element 14 to secure lifting element 14 below plate 152 between feet 151a, 151b. The top free end of rod 1631 is also threaded so as to receive at least one nut 1633 acting as axial stop for rod 1631 in the translational movement of the latter with respect to sheath 1632. The gravity applied to rope 11, to lifting element 14 and to rod 1631, thereby keeps nut 1633 pressing against the top end of sheath 1632, and rod 1631 is securedly attached to sheath 1632 in this manner. In the example illustrated, sheath 1632 and top end of rod 1631 are salient from the top end of body 161 to guarantee positioning of nut 1633 outside body 161 to enable manual access. A second nut 1633 can be added against a first nut to form a locknut.

By suitable management of the supply of piston 16 by an external supply unit, not shown, piston 162 is able to move transmission element 163 and lifting element 14 together in linear manner in direction D1. The external unit regulates the supply of fluid (air or oil depending on the type of jack 16) of at least one of the two chambers axially delineated by piston 162 inside body 161. In the case represented where jack 16 is of the single-acting type, only one of the two chambers is used as compression chamber 17, whereas return to the natural configuration of jack 16 is achieved by a return spring 18 arranged in the opposite chamber with respect to piston 162. Transfer of fluid under pressure from the external unit to the inside of compression chamber 17, and outlet of same, are successively performed by means of a supply means 19.

Jack 16 associated with the external unit thereby constitute means for moving lifting element 14 in direction D1 and tapped bore 1421 forms connecting means to the means for moving, in particular at the bottom end of rod 1631. According to the invention, lifting element 14 is formed by a globally cylindrical-shaped sleeve having a main axis of revolution oriented in a second direction D2, perpendicular to first direction D1. As set out before, the sleeve comprises a bottom shell 141 and a top shell 142. The sleeve is designed to be positioned around the section of the rope 11 that hoisting device 10 is to hoist, in such a way that second direction D2 coincides with the longitudinal direction of rope 11 and that first direction D1 corresponds to a radial direction of rope 11 having at least one vertical component. In such a position of hoisting device 10, the means for moving enable lifting element 14 to be moved selectively between a bottom position (FIG. 1) wherein the sleeve is surrounding the section of rope 11 whereas it is still resting on supports 12, and a top position (FIG. 2) where the section of rope 11 is clear of supports 12. Movement of lifting element 14 from one position to the other takes place linearly in the direction D1.

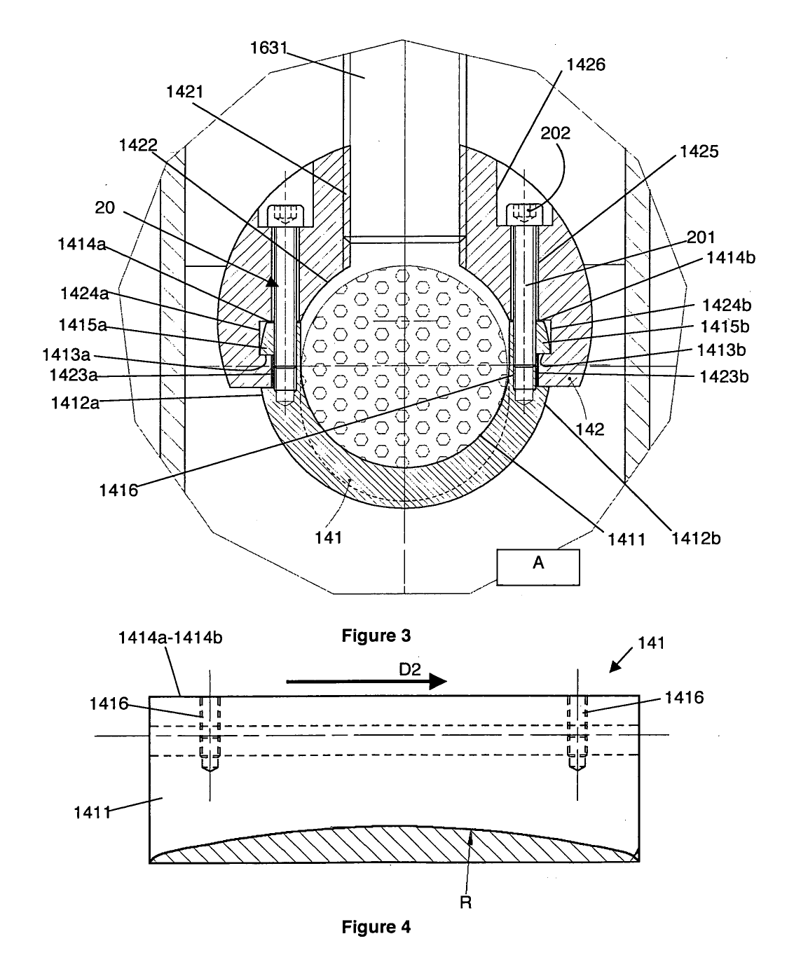

More precisely, bottom shell 141 comprises a support dish 1411 designed to be positioned pressing under the section of rope 11 that hoisting device 10 is to hoist, in order to transmit the hoisting forces thereto during movement from the bottom position to the top position. As illustrated in FIG. 4, support dish 1411 defines a groove curved on the opposite side from top shell 142 to ensure a substantially uniform distribution of the contact pressure between the hoisted section and support dish 1411 during hoisting. In a non-restrictive particular embodiment, the groove is a portion of surface of revolution having a generating line formed by an arc of a circle with a diameter that is substantially equal to that of the section to be hoisted. The radius separating the axis of the surface of revolution and the generating line is noted R in FIG. 4 and its value is substantially equal to 400 mm. The ends of the groove, considered in the direction D2, present a bevel on the opposite side from top shell 142.

In the embodiment illustrated, bottom shell 141 presents a general tubular shape with a semi-cylindrical external surface, and which internally delineates support dish 1411 described above. The external surface of bottom shell 141 therefore comprises two parallel free edges 1412a, 1412b directed in the direction D2 and designed to enable engagement with top shell 142. Each edge 1412a, 1412b for this purpose comprises a slot 1413a, 1413b over the whole length of bottom shell 141 in the direction D2. Each slot 1413a, 1413b presents a rectangular cross-section and opens out radially onto the outside of bottom shell 141. Each slot 1413a, 1413b delineates a securing edge 1415a, 1415b with end 1414a, 1414b of corresponding edge 1412a, 1412b. Each securing edge 1415a, 1415b forms a protuberance salient over the whole length in the direction D2 of bottom shell 141.

Top shell 142 comprises an overlap dish 1422 of the section of rope 11 to be hoisted, securing the latter inside support dish 1411 during movement of lifting element 14 from one position to the other. Top shell 142 presents a general tubular shape with a semi-cylindrical external surface, and which internally delineates an overlap dish 1422 that is also of semi-cylindrical shape. Overlap dish 1422 of top shell 142 therefore has two parallel free edges 1423a, 1423b oriented in the direction D2 and designed to enable engagement with bottom shell 142. Each free edge 1423a, 1423b comprises a securing slot 1424a, 1424b over the whole length of top shell 142 in the direction D2 and open onto overlap dish 1422.

It results from the foregoing that top shell 142 comprises two parallel securing slots 1424a, 1424b oriented in the direction of the main axis of the sleeve, coinciding with the second direction D2, in which slots corresponding securing edges 1415a, 1415b of bottom shell 141 can engage to perform assembly of the two shells 141, 142 by sliding in the second direction D2. The two shells 141, 142 thus comprise complementary guiding elements for such an assembly by sliding, the guiding elements being formed by securing slots 1424a, 1424b and by securing edges 1415a, 1415b.

During and subsequent to such an assembly by sliding, free edges 1423a, 1423b of overlap dish 1422 of top shell 142 each overlap a corresponding free edge 1412a, 1412b of the external surface of bottom shell 141. Nevertheless, a reversed situation could be envisaged wherein the securing slots are supported by the external surface of top shell 142 whereas the securing edges are arranged salient from the support dish. In such an alternative embodiment, the free edges of the support dish of the bottom shell would each overlap a corresponding free edge of the external surface of top shell 141. More generally, any type of complementary guiding elements achieving assembly by sliding of shells 141, 142 on one another in the direction D2 can be envisaged without departing from the scope of the invention.

Whatever the alternative embodiment of the guiding elements, each securing edge 1415a, 1415b delineates a bearing surface coming into contact with a support surface formed by a wall of associated securing slot 1424a, 1424b. Such an arrangement enables the whole of the weight of the hoisted rope 11 to be transmitted to top shell 142 moved by the means for moving via the guiding elements only. Complementary guiding elements could also be envisaged such that the bearing surfaces and support surfaces constitute a dovetail-type assembly, presenting the advantage that transmission of the forces from bottom shell 141 to top shell 142 causes automatic clamping of the two shells eliminating any risk of nuisance separation thereof.

Finally, hoisting device 10 comprises securing means disabling sliding between the two shells, top 142 and bottom 141, after the latter have been assembled by sliding. In the alternative embodiment represented, the securing means are formed by four bolts 20 each having a threaded body 201 passing through top shell 142 through a passage 1425 arranged in the direction D1 and then screwed into a tapped bore 1416 provided in bottom shell 141 in the alignment of passage 1425 after assembly. The bearing head 202 of each bolt 20 is accommodated in a counterbore 1426 provided in the external surface of top shell 142 to press on the bottom of the counterbore 1426. However, it is clear that the passages can be made in bottom shell 141 and the tapped bores be made in top shell 142 without departing from the scope of the invention. Furthermore, the spatial orientation of the passages (and therefore of bolts 20) can be any orientation. The number of bolts 20 can be variable, greater than or equal to one. More generally, any suitable securing means can be envisaged, for example a ratchet system.

Although the means for moving comprise a jack 16 in the example of a hoisting device 10 described above, any other type of means for moving can be provided as replacement for jack 16.

1. A hoisting device of a section of a rope for mechanical ski-lift installation, comprising on the one hand a lifting element designed to be positioned pressing against the rope and on the other hand means for moving the lifting element in a first direction, wherein the lifting element is formed by a sleeve having a main axis oriented in a second direction perpendicular to the first direction, designed to be positioned around the section and comprising:
a top shell having connection means connecting with the means for moving,
a bottom shell having a support dish designed to be positioned pressing under said section, the two shells comprising complementary guiding elements for assembly by sliding in the second direction,
and securing means disabling sliding between the two shells after assembly.

2. The device according to claim 1, wherein the support dish defines a groove curved on the opposite side from the top shell.

3. The device according to claim 2, wherein the groove is a portion of surface of revolution having a generating line formed by an arc of a circle the diameter whereof is substantially equal to that of the rope section to be hoisted.

4. The device according to claim 1, wherein the top shell comprises two parallel securing slots oriented in the direction of the main axis of the sleeve, corresponding securing edges of the bottom shell engaging in said slots during assembly by sliding.

5. The device according to claim 4, wherein the top shell comprises an overlap dish of the rope section having two parallel free edges each comprising a securing slot over the whole length of the top shell and open onto the overlap dish.

6. The device according to claim 1, wherein the securing means are formed by at least one bolt having a threaded body passing through one of the shells and screwed into the other shell.

7. The device according to claim 1, wherein the means for moving comprise a jack having a piston linearly moving in the first direction a transmission element securedly attached to the top shell by the connection means.

8. The device according to claim 7, wherein the transmission element comprises a rod having a threaded free end screwed into the connection means formed by a tapped bore made in the top shell.
